(19) United States
(12) Patent Application Publication
(10) Pub. No.: US 2017/0074515 A1
(43) Pub. Date: Mar. 16, 2017

(54) APPARATUS AND METHOD FOR DAMPENING ACOUSTICS

(71) Applicant: GENERAL ELECTRIC COMPANY, Schenectady, NY (US)

(72) Inventors: Shanwu WANG, Mason, OH (US); Allen Michael DANIS, Mason, OH (US); Fei HAN, Clifton Park, NY (US)

(21) Appl. No.: 14/911,857

(22) PCT Filed: Aug. 13, 2014
(86) PCT No.: PCT/US2014/050843

§ 371 Date: Feb. 12, 2016

Related U.S. Application Data
(60) Provisional application No. 61/865,361, filed on Aug. 13, 2013.

(51) Int. Cl. F23R 3/18; F23M 20/00; F23R 3/00

(52) U.S. Cl. CPC F23R 3/18; F23R 3/002; F23M 20/005; F23R 2900/00014; F05D 2260/96

(57) ABSTRACT

An apparatus for dampening acoustic pressure oscillations of a gas flow contained in part by a combustor wall of a gas turbine engine combustor. The apparatus includes at least one resonating tube with a closed end, an open end, and a cavity therebetween. The cavity is in fluid communication with an interior of the combustor such that the gas flow may flow into and out of the cavity. The apparatus further includes a perforated plate positioned at the open end and including a plurality of apertures. The gas flow flowing into and out of the cavity travels through the apertures.

### CROSS-REFERENCE TO RELATED APPLICATIONS

This application is a national stage application under 35 U.S.C. §371(c) of prior filed, co-pending PCT application serial number PCT/US2014/050843, filed on Aug. 13, 2014, which claims priority to U.S. patent application Ser. No. 61/865,361, titled “Apparatus and Method for Dampening Acoustics” filed Aug. 13, 2013. The above-listed applications are herein incorporated by reference.

### TECHNICAL FIELD

The application relates to turbines, and more specifically, to an acoustic damping apparatus to control dynamic pressure pulses in a gas turbine engine combustor.

### BACKGROUND

Destructive acoustic pressure oscillations, or pressure pulses, may be generated in combustors of gas turbine engines as a consequence of normal operating conditions depending on fuel-air stoichiometry, total mass flow, and other operating conditions. The current trend in gas turbine combustor design towards low emissions required to meet federal and local air pollution standards has resulted in the use of lean premixed combustion systems in which fuel and air are mixed homogeneously upstream of the flame reaction region. The fuel-air ratio or the equivalence ratio at which these combustion systems operate are much “leaner” compared to more conventional combustors in order to maintain low flame temperatures which in turn limits production of unwanted gaseous NOx emissions to acceptable levels. Although this method of achieving low emissions without the use of water or steam injection is widely used, the combustion instability associated with operation at low equivalence ratio also tends to create unacceptably high dynamic pressure oscillations in the combustor which can result in hardware damage and other operational problems. A change in the resonating frequency of undesired acoustics are also a result of the pressure oscillations. While current devices in the art aim to eliminate, prevent, or reduce dynamic pressure oscillations, the current devices fail to address situations where the natural frequency during operation may vary and are limited to a specific location in the turbine engine in order to function properly. There is therefore a need for an apparatus which addresses these and other issues in the art.

### SUMMARY

To that end, an apparatus configured to dampen acoustics related to pressure changes in the combustor, at varying frequencies and regardless of the position of the apparatus, is provided. Rather than being relegated to using complex systems with several complicated and/or moving parts, or designing an apparatus to include specific dimensions designed to dampen pressure only using phase compensation (by creating reflected acoustic waves that are out of phase with the incident acoustic waves from the combustion process), the present invention aims to dampen pressure in a simple and effective manner, regardless of the placement of the apparatus relative to the combustor.

In one embodiment, an apparatus for dampening acoustic pressure oscillations of a gas flow contained in part by a combustor wall of a gas turbine engine combustor is provided. The apparatus includes at least one resonating tube with a closed end, an open end, and a cavity therebetween. The cavity is in fluid communication with an interior of the combustor such that the gas flow may flow into and out of the cavity. The apparatus further includes a perforated plate positioned at the open end and including a plurality of apertures, wherein the gas flow flowing into and out of the cavity travels through the apertures.

In another embodiment, an apparatus retrofittable onto a quarter wave tube (QWT) of a gas turbine engine combustor is provided. The apparatus is adapted to increase a range of effectiveness of the quarter wave tube with respect to dampening acoustic pressure oscillations in the combustor, the acoustic pressure oscillations resonating at a resonating frequency. The quarter wave tube retrofitted with the apparatus being configured to dampen the acoustic pressure oscillations at a target frequency, where the target frequency is within approximately 250 Hz of the resonating frequency.

In another embodiment, a method of dampening acoustic pressure oscillations of a gas flow contained in part by a combustor wall of a gas turbine engine combustor is provided. The method includes fluidicly communicating a cavity of a resonating tube with an interior of the combustor such that the gas flow may flow into and out of the cavity. The combustor includes a closed end, an open end, and the cavity therebetween. The method further includes positioning a perforated plate at the open end of the resonating tube, the perforated plate including a plurality of apertures, wherein the gas flow flowing into and out of the cavity travels through the apertures.

### BRIEF DESCRIPTION OF THE DRAWINGS

FIG. 1 shows a portion of an apparatus for dampening acoustics in a gas turbine engine combustor, including a housing.

FIG. 2 shows a rear perspective view of the apparatus of FIG. 1.

FIG. 3 shows a side view of the apparatus of FIG. 1.

FIG. 4 shows a perspective cross-sectional view of the apparatus of FIG. 1, showing a cavity.

FIG. 5 shows a plot of effectiveness of dampening acoustics of a prior art apparatus.

FIG. 6 shows a plot of effectiveness of dampening acoustics of one embodiment of the invention.

FIG. 7 shows at least gas flow and temperature characteristics of a prior art device, shown in schematic form.

FIG. 8 shows the effect of at least gas flow and temperature characteristics associated with of one embodiment of the invention, shown in schematic form.

### DETAILED DESCRIPTION

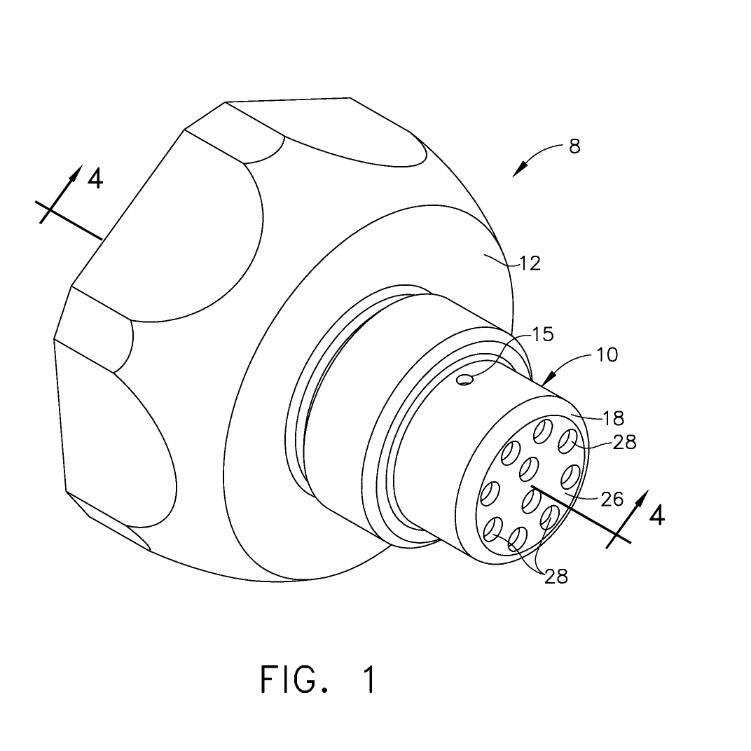

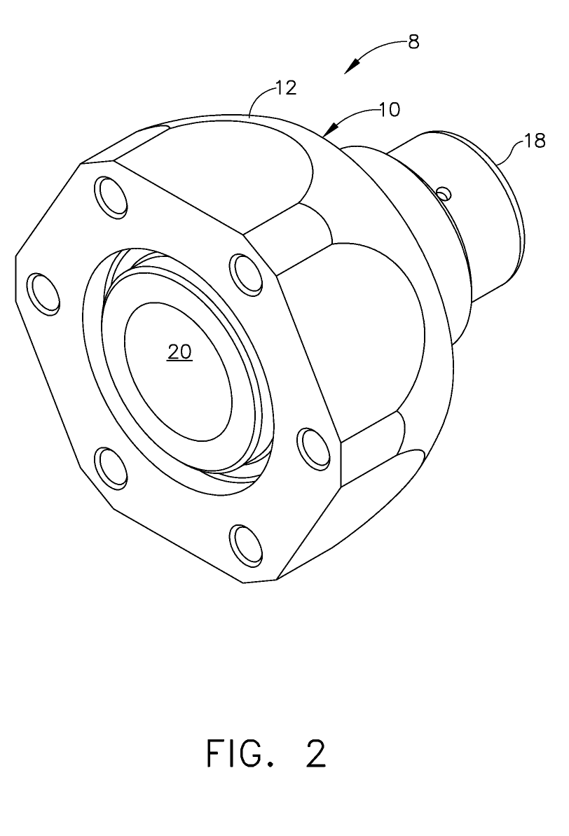

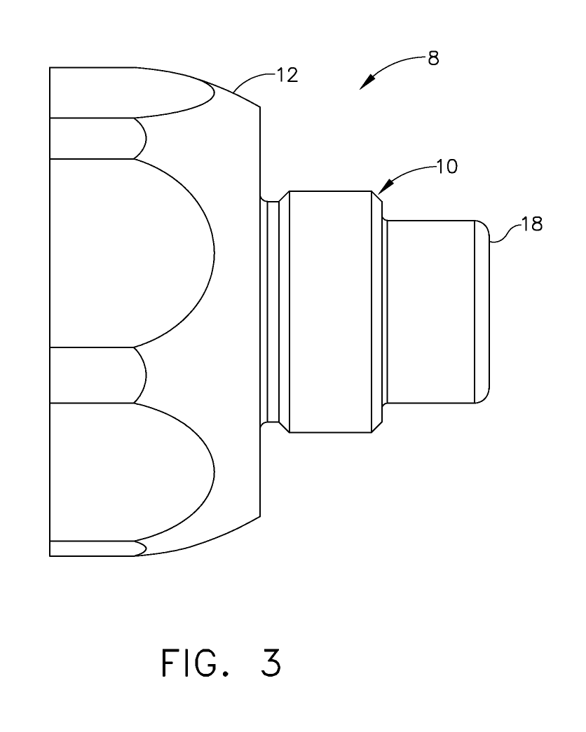

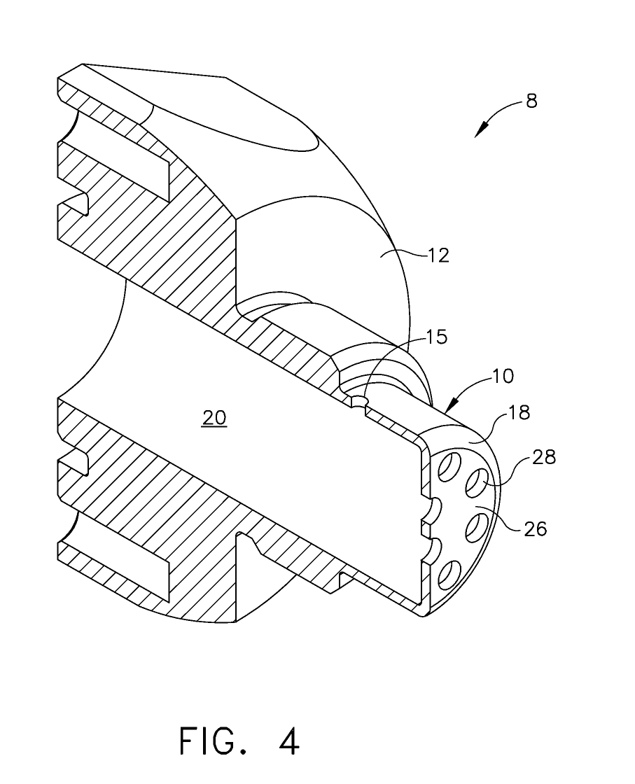

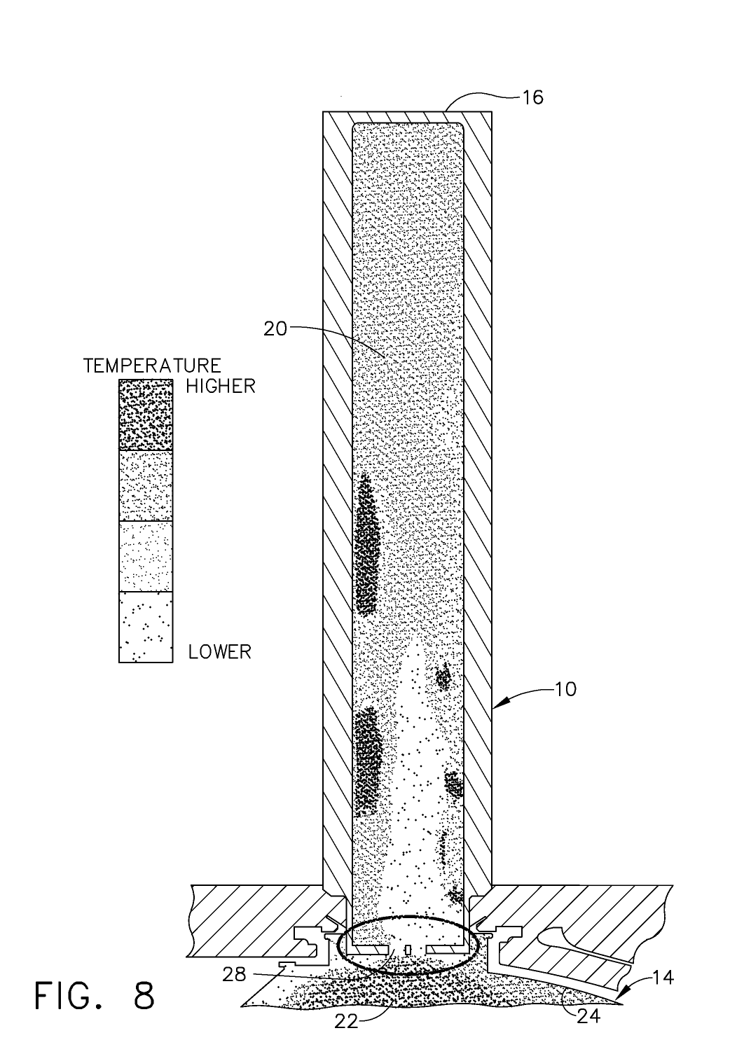

Referring to FIGS. 1-4, an apparatus 8 includes a resonating tube 10 at least partially encased with a housing 12. The housing 12 shown is optional and may be used in some embodiments to assist in affixing the resonating tube 10 relative to a combustor 14 such that the resonating tube 10 may dampen acoustic pressure oscillations of a gas flow contained by the combustor 14. The resonating tube includes a purge hole 15. The resonating tube 10 includes a closed end 16, an open end 18, and a cavity 20 therebetween. The resonating tube 10 is placed in fluid communication with an interior 22 of the combustor 14 such that the gas flow may flow into and out of the cavity 20. The open end 18 is essentially flush with an inner surface 24 of the combustor 14. FIGS. 1-4 show only a portion of the length of the resonating tube 10 and it is appreciated that the resonating tube 10 may have a longer length than that shown (see, for example, FIG. 8).

A perforated plate 26 is positioned at the open end 18 and includes a plurality of apertures 28 such that the gas flow flowing into and out of the cavity 20 travels through the apertures 28. While only one perforated plate 26 is shown, it is possible that more than one perforated plate 26 may be utilized. Moreover, it is possible that in other embodiments the perforated plate 26 could have more or less apertures 28 than shown, and that the apertures 28 may be different shapes than shown. Furthermore, the perforated plate 26 may be integral with the remainder of the resonating tube 10 or may be a separate component that may be fixed at or near the open end 18 of the resonating tube 10. For example, the perforated plate 26 may be retrofitted onto an existing quarter wave tube of a combustor. To that end, an embodiment of a perforated plate 26 would be retrofittable onto or into an existing quarter wave tube of a gas turbine engine combustor. It will be appreciated that the perforated plate 26 may be retrofitted onto an existing quarter wave tube of a combustor in order to provide the same or similar benefits as different embodiments of the apparatus 8.

It will be understood that dynamic pressure pulses or acoustic pressure oscillations associated with the operation of a combustor impose excessive mechanical stress on the gas turbine engine. The current trend in gas turbine combustor design towards low NOx emissions required to meet federal and local air pollution standards has resulted in the use of premixed combustion systems, wherein fuel and air are mixed homogeneously upstream of the flame reaction region using the relatively open flow type of swirl mixers which establishes a feedback loop which in turn permits the acoustic oscillations or their pressure waves to bounce back and forth between the stage of turbine inlet guide vanes and the stage of compressor outlet guide vanes, essentially unimpeded, and through the entire length of the combustor. An example of such a combustor is disclosed in U.S. Pat. No. 7,059,135, which is incorporated herein by reference, in its entirety. The fuel-air ratio or the equivalence ratio at which these combustion systems operate are much “leaner” compared to conventional combustors to maintain low flame temperatures to limit the gaseous NOx emissions to the required level. Although this method of achieving low emissions without the use of water or steam injection is widely used, the combustion instability associated with operation at low equivalence ratio also creates unacceptably high dynamic pressure oscillations in the combustor resulting in hardware damage and other operational problems. To this end the technology described herein, an apparatus for suppressing or attenuating the pressure pulses from acoustic pressure oscillations within combustor was developed. Unlike other devices in the art, the apparatus 8 may be used effectively on the “cold-side” or the “hot-side” of the turbine engine. “Cold-side,” as described herein, is meant to refer to areas upstream of the air/fuel mixer, while “hot side” is meant to refer to areas downstream of the air/fuel mixer.

FIG. 5 shows a graph which shows the effectiveness of a typical quarter wave tube as known in the art. As shown, the absorption coefficient is generally less than 0.4, or 40%, once the resonating or actual frequency of acoustic pressure oscillations in the combustor 14 is no longer within approximately 25 Hz of the target frequency. When describing whether a certain stated value (of frequency, e.g.) is “within approximately n (Hz, e.g.)” of a certain value, it is meant that the stated value is within plus or minus approximately n, unless otherwise stated. “Target frequency” as used herein is meant to describe the range at which the combustor 14 is meant to operate, or the frequency at which a dampening device is designed to be most effective (i.e., where the absorption coefficient is approximately 1, or 100%). “Resonating frequency” is meant to describe the actual frequency at which the combustor 14 is operating, including times during which acoustic pressure oscillations are occurring. Only at a very narrow range is the typical quarter wave tube of the prior art effective at dampening 100% of acoustic pressure oscillations, which is shown at the point where the absorption coefficient equals 1, or 100%.

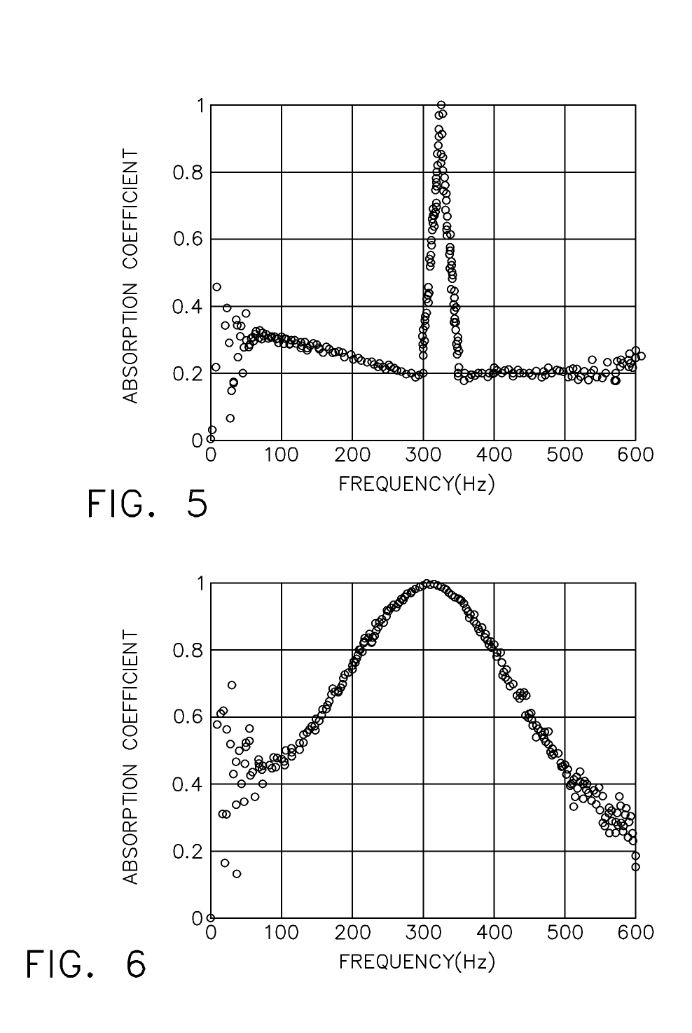

FIG. 6 shows a graph of the effectiveness of one embodiment of the apparatus 8 as disclosed herein in dampening acoustic pressure oscillations. Rather than being effective within approximately 25 Hz of the target frequency, the resonating tube 10 is configured to dampen the acoustic pressure oscillations resonating within approximately 250 Hz of the target frequency. While the effectiveness (as shown by the absorption coefficient) decreases as the actual, resonating frequency deviates further from the target frequency, the resonating tube 10 as described herein dampens acoustic pressure oscillations more effectively than the devices known in the art. As shown, the resonating tube 10 is configured to dampen at least 40% of the acoustic pressure oscillations when the resonating frequency is within approximately 250 Hz of the target frequency. Further, the resonating tube 10 is configured to dampen at least 60% of the acoustic pressure oscillations when the resonating frequency is within approximately 150 Hz of the target frequency. Even further, the resonating tube 10 is configured to dampen at least 80% of the acoustic pressure oscillations when the resonating frequency is within approximately 100 Hz of the resonating frequency.

Such ranges of operating frequencies shown in FIGS. 5 and 6 are specific to one embodiment of a combustor 14 and it is appreciated that the apparatus 8 is effective as described with respect to other ranges of frequencies, whether lower or higher than those shown in FIGS. 5 and 6. When lean combustors are operated at different power levels, the associated fuel staging might result in different frequencies in combustors, which could be 100 Hz apart. Due to the wide range of resonating frequencies that occur when the power level changes (which results in undesired acoustics as described herein), a QWT of the prior art would be ineffective along a significant portion of operation of the combustor 14.

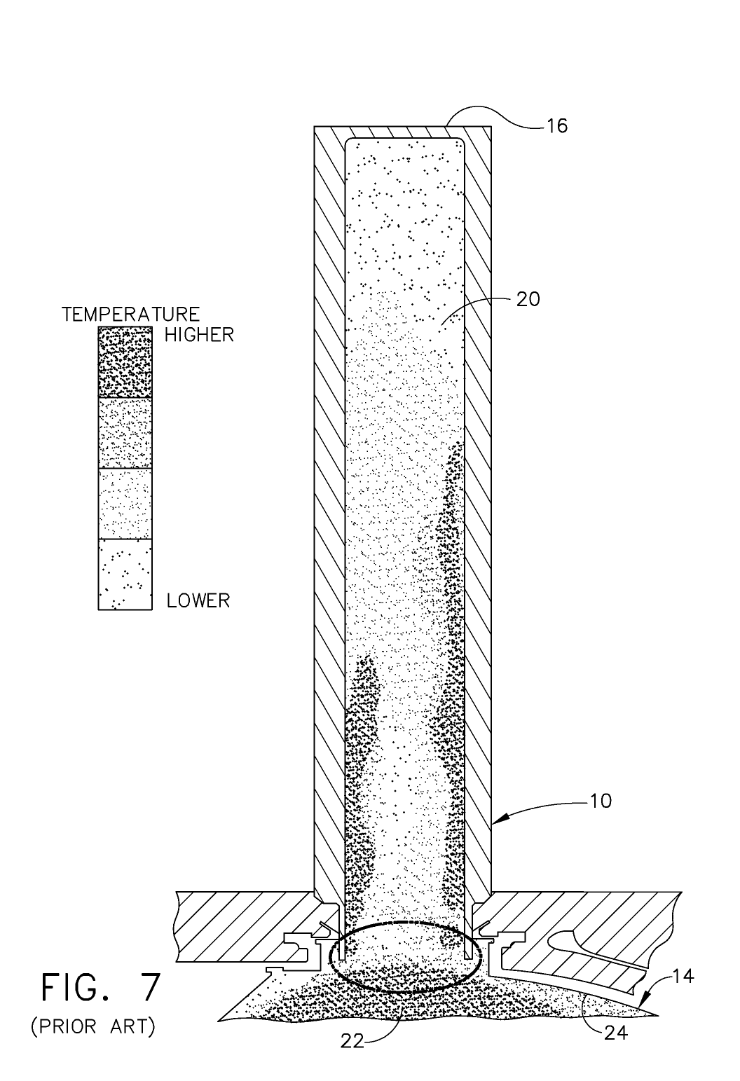

The effectiveness of the apparatus 8 as described herein is due in part to the bias flow that results from the placement of the perforated plate 26. Rather than relying solely on phase compensation (by creating reflected acoustic waves that are out of phase with the incident acoustic waves from the combustion process), as is the case with typical QWTs, the apparatus 8 as disclosed herein, and the resulting bias flow that occurs, dampens pressure oscillations to heat caused by viscosity, among other things. FIG. 7 (worst condition) shows the temperature variance as well as vortices created in the QWT and the combustor, of the prior art QWT, while FIG. 8 shows the same characteristics with one embodiment of the resonating tube 10 as described herein. The first effect of the resonating tube 10 as disclosed herein is that the temperature of the resonating tube 10 including the perforated plate 26 lowers the temperature within the resonating tube 10 itself. With respect to the prior art figure, there is more ingested hot gas visible within the resonating tube 10 (as shown by the areas of increased temperature) compared to the figure of the present disclosure. The hot gas ingestion further decreases the effectiveness of the prior art device because the speed of sound is proportional to temperature, and wavelength of acoustics (such as acoustic pressure oscillations) is dependent on the speed of sound. Thus, increasing temperature inside the QWT changes the wavelength of the oscillations. Because typical QWTs are designed to operate effectively with a specific acoustic wavelength, changing the wavelength decreases the effectiveness of the QWT.

With attention to FIG. 8 (worst condition), the apparatus 8 as disclosed herein prevents the mentioned hot gas ingestion due in part by the bias flow. The bias flow out of the resonating tube 10 allows less of the hot combustion gas from entering the resonating tube 10, which contributes to a lower internal temperature of the resonating tube 10, and thus a higher effectiveness for the reasons described above. While the embodiment of the resonating tube 10 as described herein does not rely solely on matching the length thereof to the wavelength of the acoustics in the turbine engine, preventing the change in wavelength due to increased temperature in the resonating tube 10 may increase its effectiveness.

The second effect of the apparatus 8 is converting undesired acoustics energy to vortical energy. The vortical energy is eventually dampened or dissipated, and converted to heat due to the viscosity of the gas flow in the combustor 14. The vortices (shown in the QWT and not shown in the combustor 14) caused by flow oscillation crossing the orifices increase the turbulence viscosity, leading to dissipation of heat within the combustor 14. The bias flow due to the perforated plate 26 of the apparatus 8, in addition, dampens the viscosity along at least the wall of the combustor 14. The bias flow also absorbs acoustic pressure oscillation such that the absorption coefficient (see FIG. 6) is increased.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. Such other examples are intended to be within the scope of the claims if they have structural elements that do not differ from the literal language of the claims, or it they include equivalent structural elements with insubstantial differences from the literal languages of the claims.

What is claimed is:

1. An apparatus for dampening acoustic pressure oscillations of a gas flow contained in part by an inner surface of a combustor of a gas turbine engine combustor, the apparatus comprising:
at least one resonating tube with a closed end, an open end, and a cavity therebetween, the cavity being in fluid communication with an interior of the combustor such that the gas flow may flow into and out of the cavity; and
a perforated plate positioned at the open end and including a plurality of apertures, wherein the gas flow flowing into and out of the cavity travels through the apertures.

2. The apparatus of claim 1, wherein the gas flow out of the cavity is in the form of bias flow.

3. The apparatus of claim 1, wherein the gas flow out of the cavity is configured to dampen a viscosity of the gas flow.

4. The apparatus of claim 1, wherein the resonating tube is positioned upstream of an air/fuel mixer.

5. The apparatus of claim 1, wherein the resonating tube is positioned downstream of an air/fuel mixer.

6. The apparatus of claim 1, wherein a power output of the combustor is variable.

7. The apparatus of claim 1, wherein the resonating tube has a hollow cylindrical form.

8. The apparatus of claim 1, wherein:
acoustic pressure oscillations of the combustor resonate at a resonating frequency,
the resonating tube is configured to dampen the acoustic pressure oscillations resonating at a target frequency, the target frequency being within approximately 250 Hz of the resonating frequency.

9. The apparatus of claim 8, wherein the resonating tube is configured to dampen at least 40% of the acoustic pressure oscillations when the resonating frequency is within approximately 250 Hz of the target frequency.

10. The apparatus of claim 8, wherein the resonating tube is configured to dampen at least 60% of the acoustic pressure oscillations when the resonating frequency is within approximately 150 Hz of the target frequency.

11. The apparatus of claim 8, wherein the resonating tube is configured to dampen at least 80% of the acoustic pressure oscillations when the resonating frequency is within approximately 100 Hz of the target frequency.

12. The apparatus of claim 8, wherein the target frequency is between approximately 300 Hz and approximately 500 Hz.

13. An apparatus retrofittable onto a quarter wave tube of a gas turbine engine combustor, the apparatus adapted to increase a range of effectiveness of the quarter wave tube with respect to dampening acoustic pressure oscillations in the combustor, the acoustic pressure oscillations resonating at a resonating frequency, the quarter wave tube retrofitted with the apparatus being configured to dampen the acoustic pressure oscillations at a target frequency, the target frequency being within approximately 250 Hz of the resonating frequency.

14. The apparatus of claim 13, wherein the quarter wave tube is located upstream of an air/fuel mixer.

15. The apparatus of claim 13, wherein the quarter wave tube is located downstream of an air/fuel mixer.

16. The apparatus of claim 13, being further defined as a perforated plate.

17. The apparatus of claim 16, being positioned at an open end of the quarter wave tube, the open end in communication with an interior of the combustor.

18. A method of dampening acoustic pressure oscillations of a gas flow contained in part by an inner surface of a combustor of a gas turbine engine combustor, the method comprising:
fluidicly communicating a cavity of a resonating tube with an interior of the combustor such that the gas flow may flow into and out of the cavity, the combustor including a closed end, an open end, and the cavity therebetween;
positioning a perforated plate at the open end of the resonating tube, the perforated plate including a plurality of apertures, wherein the gas flow flowing into and out of the cavity travels through the apertures.

19. The method of claim 18, wherein acoustic pressure oscillations of the combustor resonate at a resonating frequency and the method further comprises dampening the acoustic pressure oscillations resonating at a target frequency, the target frequency being within approximately 250 Hz of the resonating frequency.

20. The method of claim 18, wherein the target frequency is between approximately 300 Hz and approximately 500Hz.
